(19) United States
(12) Patent Application Publication
(10) Pub. No.: US 2015/0002125 A1
(43) Pub. Date: Jan. 1, 2015

(54) DC-DC CONVERTER

(71) Applicants: Akihiro Kinoshita, Aichi (JP); Ryo Kobayashi, Aichi (JP)

(72) Inventors: Akihiro Kinoshita, Aichi (JP); Ryo Kobayashi, Aichi (JP)

(73) Assignee: OMRON AUTOMOTIVE ELECTRONICS CO., LTD., Aichi (JP)

(21) Appl. No.: 14/316,288

(22) Filed: Jun. 26, 2014

(30) Foreign Application Priority Data
Jun. 26, 2013 (JP) 2013-133342

(51) Int. Cl. H02M 3/155; H02M 1/32

(52) U.S. Cl. CPC H02M 3/155; H02M 1/32
USPC 323/285

(57) ABSTRACT

A DC-DC converter that is capable of cutting off a large current flowing in a voltage converter circuit when a short-circuit failure occurs in a switching element of the voltage converter circuit includes a voltage converter circuit having a first switching element, a reverse connection protection second switching element that blocks a large current from flowing in the voltage converter circuit when a negative electrode of a DC power supply is connected to an input terminal, a reverse connection protection third switching element that blocks a large current from flowing in the voltage converter circuit when a short-circuit failure occurs in the first switching element, and a detector that detects the short-circuit failure in the first switching element to turn off the third switching element. The third switching element is connected in series with the second switching element.

### BACKGROUND OF THE INVENTION

1. Technical Field

The present invention relates to a DC-DC converter (DC-DC converter device) that boosts or steps down the voltage of a DC power supply to supply the voltage to a load and, in particular, a DC-DC converter including a protecting function used when a DC power supply is reversely connected to the DC converter.

2. Related Art

For example, a DC-DC converter is mounted on an automobile as a power supply device to supply a DC voltage to various onboard devices or circuits. In general, a DC-DC converter has a voltage converter circuit (booster circuit or step-down circuit) including a switching element, a coil, a capacitor, and the like, and switches voltages of a DC power supply at a high speed to output a boosted or stepped-down DC voltage.

In such a DC-DC converter, when the positive and negative voltages of the DC power supply are reversely connected to input terminals, a large current flows in the circuit so as to break down the element. At this time, even though the DC power supply is reversely connected, in order to prevent the element from being broken down, a reverse connection protection circuit is conventionally disposed. Japanese Unexamined Patent Publication No. 2005-51919 and Japanese Unexamined Patent Publication No. 2006-14491 (will be described later) show a power supply device on which the reverse connection protection circuit is disposed.

In Japanese Unexamined Patent Publication No. 2005-51919, a reverse connection protection FET (field effect transistor) is connected in series with an overvoltage protection FET, and a voltage detection circuit that detects the voltage of a DC power supply is disposed. When a voltage detected by the voltage detection circuit exceeds a predetermined value with a power supply switch being turned on, the overvoltage protection FET is turned off to prevent the circuit element of a power conversion circuit from being broken down. When the power supply switch is turned on with the DC power supply being reversely connected, the reverse connection protection FET is turned off to prevent the circuit element of the power conversion circuit from being broken down.

In Japanese Unexamined Patent Publication No. 2006-14491, a reverse connection protection FET that is turned on when a power supply is connected in the forward direction and turned off when the power supply is connected in the reverse direction is disposed on a power supply path, and a booster circuit that boosts an output from the FET is disposed. On the basis of the output from the booster circuit, the FET is turned on. Even though the power supply voltage is low, a stable output voltage can be supplied.

In the DC-DC converter, even though a load connected to an output terminal is short-circuited, a large current flows in the circuit to break down the element. As a countermeasure against the problem, a power supply device including an overcurrent protection function that restricts a current flowing in the switching element of the booster circuit on the basis of a first reference value and a short-circuit protection function that quickly restricts the current on the basis of a second reference voltage larger than the first reference value is described in Japanese Unexamined Patent Publication No. 2012-157191 (will be described later).

FIG. 9 shows an example of a conventional DC-DC converter including a protection circuit taking a measure against reverse connection of a DC power supply. A DC-DC converter 200 includes an input terminal 61, an input filter 51, a booster circuit 52, an output filter 53, an output terminal 62, a controller 54, an FET drive circuit 55, and a reverse connection protection FET 60. A DC power supply 50 is connected to the input terminal 61, and a load 70 is connected to the output terminal 62.

The booster circuit 52 is a known circuit including a coil 56, a switching FET 57, a synchronous rectification FET 58, and a capacitor 59. The FET 57 and FET 58 are alternatively turned on or off with a pulse signal (PWM signal) given by the FET drive circuit 55. More specifically, the FET 58 is turned off when the FET 57 is turned on, and the FET 57 is turned off when the FET 58 is turned on. The FET 60 is always in an on state with a control signal from the controller 54. Diodes 57a, 58a, and 60a (inter-drain-source parasitic diodes) are connected to the FETs 57, 58, and 60 in reversely parallel to each other, respectively.

A voltage from the DC power supply 50 is input to the booster circuit 52 through the input filter 51. An on/off-operation of the FET 57 switches the voltages of the DC power supply 50 to generate a high voltage at the coil 56. The high voltage is rectified with the diode 58a of the FET 58, smoothed with the capacitor 59, and then supplied to the load 70 as a boosted DC voltage through the output filter 53.

When the DC power supply 50 is reversely connected, i.e., when the negative electrode and the positive electrode of the DC power supply 50 are connected to the input terminal 61 and the ground, respectively, the FET 60 is set in an off state. Since the cathode of the diode 60a of the FET 60 is connected to the positive electrode of the DC power supply 50, the diode 60a becomes non-conductive. For this reason, a large current does not flows in the path given by the positive electrode of the DC power supply 50→the ground→the FET 60→the FET 57→the coil 56→the input filter 51 the negative electrode of the DC power supply 50, and circuit elements on the path are prevented from being broken down.

In the DC-DC converter 200 shown in FIG. 9, a short-circuit failure may occur in the switching FET 57. The “short-circuit failure” means a failure in which the source and the drain of the FET 57 are fixedly set in a conductive state to always set the FET 57 in an on state and to make it impossible to turn off the FET 57. When the short-circuit failure occurs, even though the reverse connection protection FET 60 connected in series with the FET 57 is turned off, the diode 60a of the FET 60 is in a forward direction with respect to the DC power supply 50. For this reason, a large current indicated by a thick arrow in FIG. 10 flows through the FET 57 and the diode 60a. More specifically, the FET 60 in an off state cannot block the large current, and the large current continuously flows to break down the circuit elements on the current path.

Since the power supply device in Japanese Unexamined Patent Publication No. 2005-51919 detects an over-voltage on the input side to turn off an overvoltage protection FET, even though a short-circuit failure occurs in the switching element of a power conversion circuit to cause an overcurrent to flow in a power conversion circuit, the overcurrent cannot be detected. Since the power supply device in Japanese Unexamined Patent Publication No. 2006-14491 is to drive a reverse connection protection FET with an output voltage from a booster circuit, even though a short-circuit failure occurs in the switching element of the booster circuit to cause an overcurrent in the booster circuit, the overcurrent cannot be detected. The power supply device of Japanese Unexamined Patent Publication No. 2012-157191 takes a measure against a short circuit occurring on the output side, and does not take a measure against a short circuit occurring in the switching element of a voltage converter circuit.

### SUMMARY

One or more embodiments of the present invention provide a DC-DC converter that is capable of cutting off a large current flowing in a voltage converter circuit when a short-circuit failure occurs in the switching element of the voltage converter circuit.

In accordance with one aspect of embodiments of the present invention, a DC-DC converter including an input terminal to which a positive electrode of a DC power supply is connected, an output terminal to which a load is connected, a voltage converter circuit that is disposed between the input terminal and the output terminal, has a first switching element, and boosts or steps down a voltage of the DC power supply depending on an on/off-operation of the first switching element to supply the voltage to the load, and a reverse connection protection second switching element that blocks a large current from flowing in the voltage converter circuit when the negative electrode of the DC power supply is connected to the input terminal further includes a short-circuit protection third switching element that blocks a large current from flowing in the voltage converter circuit when a short-circuit failure occurs in the first switching element, and a detector that detects the short-circuit failure in the first switching element to turn off the third switching element. The third switching element is connected in series with the second switching element. The detector detects the failure on the basis of a voltage at a connection point between the first switching element and a series circuit of the second and third switching elements.

With the configuration, when a short-circuit failure occurs in the first switching element of the voltage converter circuit, a large current flowing in the voltage converter circuit increases the voltage at the connection point. When the detector detects the increase in voltage, the short-circuit protection third switching element is turned off. Thus, the third switching element cuts off a large current that cannot be cut off by the second switching element. In this manner, when a short-circuit failure occurs in the first switching element, a circuit element disposed on a path in which the large current flows can be protected from being broken down.

In one or more embodiments of the present invention, the detector may include a voltage-dividing resistor that divides the voltage at the connection point and a fourth switching element that is turned on/off when the voltage divided by the voltage-dividing resistor is a predetermined value or higher. In this case, the third switching element is turned off by turning on/off the fourth switching element.

In one or more embodiments of the present invention, the detector may include a controller that determines the presence/absence of a failure on the basis of the voltage at the detection point and outputs a control signal when the detector determines that the failure occurs, and a fifth switching element that is turned on/off on the basis of the control signal. In this case, the third switching element is turned off by turning on/off the fifth switching element.

In one or more embodiments of the present invention, the detector may include a first detector and a second detector. In this case, the first detector includes a voltage-dividing resistor that divides the voltage at the connection point and a fourth switching element that is turned on/off when the voltage divided by the voltage-dividing resistor is equal to or higher than a predetermined value, the second detector includes a controller that determines the presence/absence of the failure on the basis of the voltage at the connection point and outputs a control signal when the controller determines that the failure occurs and a fifth switching element that is turned on/off on the basis of the control signal, and the third switching element may be configured to be turned off by turning on/off the fourth switching element in the first detector or turning on/off the fifth switching element in the second detector.

In one or more embodiments of the present invention, the first to third switching elements include MOSFETs configured by arranging diodes between a source and a drain, the diodes of the first and third switching elements are connected to the DC power supply in a reverse direction, and the diode of the second switching element is connected to the DC power supply in a forward direction.

In this case, the drain of the first switching element is connected to a power supply line on a positive electrode side of the DC power supply, the source of the first switching element is connected to the drain of the third switching element, the source of the third switching element is connected to the source of the second switching element, and the drain of the second switching element is connected to the ground.

According to one or more embodiments of the present invention, there can be provided a DC-DC converter that is capable of cutting off a large current flowing in a voltage converter circuit when a short-circuit failure occurs in a switching element of the voltage converter circuit.

### BRIEF DESCRIPTION OF THE DRAWINGS

FIG. 1 is a circuit diagram of a DC-DC converter according to one or more embodiments of the present invention;

FIG. 2 is a circuit diagram showing a current path in a normal state;

FIG. 3 is a circuit diagram for explaining current cutting-off in a reverse connection state of a DC power supply;

FIG. 4 is a circuit diagram showing a current path in occurrence of a short-circuit failure;

FIG. 5 is a circuit diagram for explaining current cutting-off in occurrence of a short-circuit failure;

FIG. 6 is a circuit diagram for explaining current cutting-off in occurrence of a short-circuit failure;

FIG. 7 is a flow chart showing an operation of a controller;

FIGS. 8A and 8B are graphs showing changes in current and voltage in occurrence of a short-circuit failure;

FIG. 9 is a circuit diagram of a conventional DC-DC converter; and

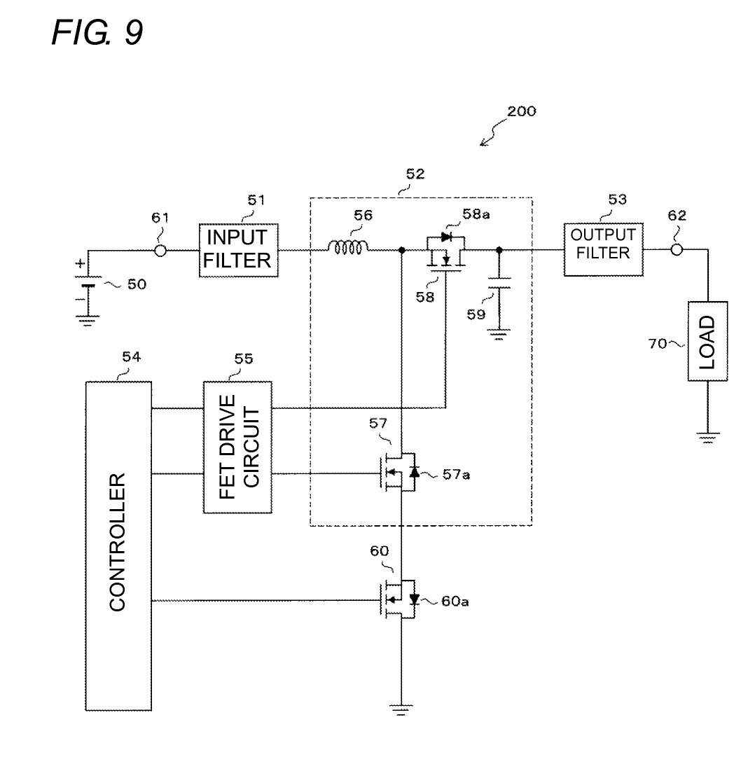

FIG. 10 is a circuit diagram showing a conventional current path in occurrence of a short-circuit failure.

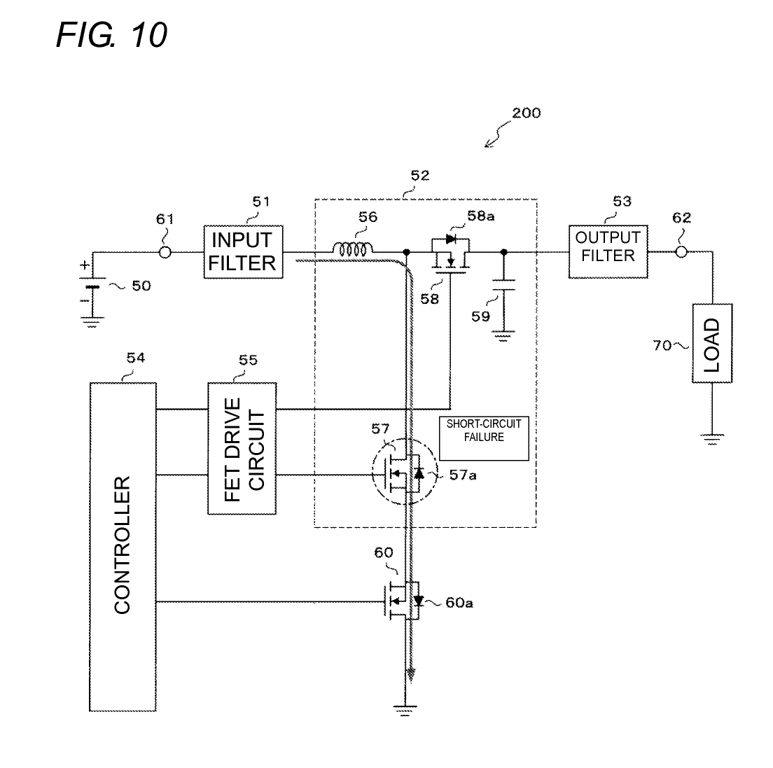

### DETAILED DESCRIPTION

Embodiments of the present invention will be described below with reference to the accompanying drawings. The same reference numerals as in the drawings denote the same parts in the drawings.

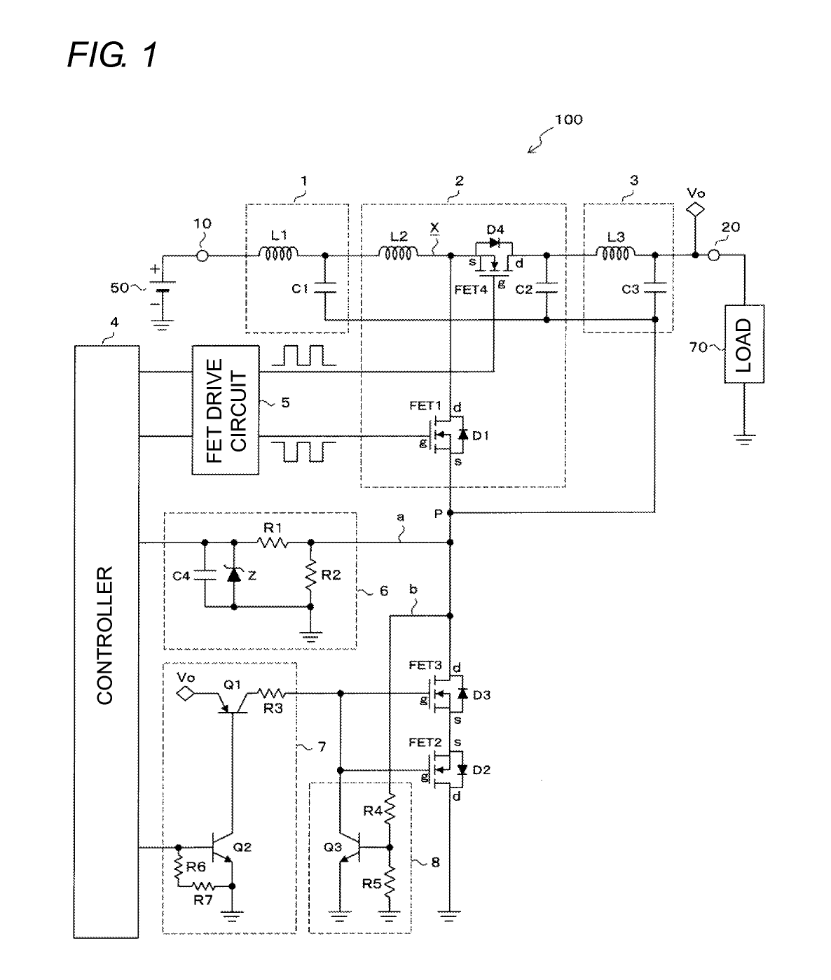

First, the configuration of a DC-DC converter according to one or more embodiments of the present invention will be described below with reference to FIG. 1. A DC-DC converter 100 includes an input terminal 10, an input filter 1, a voltage converter circuit 2, an output filter 3, an output terminal 20, a controller 4, an FET drive circuit 5, a protection circuit 6, an FET control circuit 7, a short-circuit detection circuit 8, a reverse connection protection FET 2, and a short-circuit protection FET 3. The positive electrode of the DC power supply 50 is connected to the input terminal 10, and the load 70 is connected to the output terminal 20. The DC power supply 50 is an on-vehicle battery mounted on, for example, an automobile, and the load 70 is an ECU (Electronic Control Unit) for controlling, for example, an engine, an onboard device, or the like. A power supply line X on a positive electrode side of the DC power supply 50 extends from the input terminal 10 to the output terminal 20.

The input filter 1 is a known circuit configured by a coil L1 and a capacitor C1 to remove noise from the DC power supply 50 connected to the input terminal 10. The coil L1 configures the power supply line X partially. One end of the coil L1 is connected to the input terminal 10, and the other end is connected to one end of a coil L2 (will be described later). One end of the capacitor C1 is connected to a connection point between the coils L1 and L2 on the power supply line X. The other end of the capacitor C1 is connected to a connection point P. The connection point P is a connection point between the FET 1 and a series circuit of the FET 2 and the FET 3.

The voltage converter circuit 2 is a known booster circuit including the coil L2, a capacitor C2, the switching FET 1, and a synchronous rectification FET 4 to boost the voltage of the DC power supply 50. The coil L2 and the FET 4 configure the power supply line X partially. One end of the coil L2 is connected to the other end of the coil L1, and the other end of the coil L2 is connected to a source s of the FET 4. A drain d of the FET 4 is connected to one end of a coil L3 (will be described later), and a gate g of the FET 4 is connected to the output side of the FET drive circuit 5. A drain d of the FET 1 is connected to a connection point between the coil L2 and the FET 4 on the power supply line X. A source s of the FET 1 is connected to the connection point P, and a gate g of the FET 1 is connected to the output side of the FET drive circuit 5. One end of the capacitor C2 is connected to a connection point between the FET 4 and the coil L3 on the power supply line X, and the other end is connected to the connection point P.

The FET 1 is a MOSFET that is obtained by connecting a diode D1 (parasitic diode) in parallel between the source s and the drain d. The FET 4 is a MOSFET that is obtained by connecting a diode D4 (parasitic diode) in parallel between the source s and the drain d.

An output filter 3 is a known circuit including the coil L3 and a capacitor C3 to remove noise included in an output from the voltage converter circuit 2. The coil L3 configures the power supply line X partially. One end of the coil L3 is connected to the drain d of the FET 4, and the other end is connected to the output terminal 20. One end of the capacitor C3 is connected to a connection point between the coil L3 and the output terminal 20 on the power supply line X, and the other end is connected to the connection point P.

The controller 4 includes a CPU, a memory, and the like to control the operation of the DC-DC converter 100. The controller 4 performs communication with a host device (not shown). A command signal such as a boosting command from the host device is input to the controller 4.

The FET drive circuit 5 is a circuit to drive the FET 1 and the FET 4, and receives a signal from the controller 4 to output a pulse signal (PWM signal) as shown in the drawing to the gates g of the FETs. The FET 1 and the FET 4 are alternately turned on/off with a pulse given by the FET drive circuit 5. More specifically, the FET 4 is turned off when the FET 1 is turned on, and the FET 1 is turned off when the FET 4 is turned on.

The protection circuit 6 includes resistors R1 and R2, a zener diode Z, and a capacitor C4. The input side of the protection circuit 6 is connected to a short-circuit failure detection line a, and the output side is connected to the controller 4. The short-circuit failure detection line a is connected to the connection point P. The protection circuit 6 is disposed to prevent an overvoltage from being applied to the controller 4 through the short-circuit failure detection line a.

The FET control circuit 7 is a circuit that on/off-controls the FET 2 and the FET 3, and includes transistors Q1 and Q2, resistors R3, R6, and R7. A voltage Vo output to the output terminal 20 is supplied to the emitter of the transistor Q1. The collector of the transistor Q1 is connected to the gate g of the FET 3 and the gate g of the FET 2 through the resistor R3. The base of the transistor Q1 is connected to the collector of the transistor Q2. The emitter of the transistor Q2 is connected to the ground, and the base thereof is connected to the controller 4. The resistors R6 and R7 are disposed across the base and the emitter of the transistor 02.

The short-circuit detection circuit 8 is a circuit that detects a short-circuit failure in the FET 1, and includes a transistor Q3 and resistors R4 and R5. The collector of the transistor Q3 is connected to the gate g of the FET 3 and the gate g of the FET 2. The emitter of the transistor Q3 is connected to the ground. The base of the transistor Q3 is connected to a connection point between the resistors R4 and R5. The resistors R4 and R5 configure voltage-dividing resistors that divide a voltage at the connection point P. One end of the resistor R4 is connected to the connection point P through a short-circuit failure detection line b, and the other end is connected to one end of the resistor R5. The other end of the resistor R5 is connected to the ground.

The FET 2 is a reverse connection protection MOSFET that is obtained by connecting a diode D2 (parasitic diode) in parallel between the source s and the drain d. The FET 3 is a short-circuit protection MOSFET that is obtained by connecting a diode D3 (parasitic diode) in parallel between the source s and the drain d.

The FET 2 and the FET 3 are connected in series with each other, and the series circuit is connected in series with the FET 1. The drain d of the FET 1 is connected to the power supply line X on the positive electrode side of the DC power supply 50, the source s of the FET 1 is connected to the drain d of the FET 3, the source s of the FET 3 is connected to the source s of the FET 2, and the drain d of the FET 2 is connected to the ground. The diode D1 of the FET 1 and the diode D3 of the FET 3 are connected to the DC power supply 50 in a reverse direction, and the diode D2 of the FET 2 is connected to the DC power supply 50 in a forward direction.

In the above configuration, the FET 1 is an example of the “first switching element” in the present invention, the FET 2 is an example of the “second switching element”, and the FET 3 is an example of the “third switching element”. The transistor Q3 is an example of the “fourth switching element” in the present invention, and the transistor Q1 is an example of the “fifth switching element”. The short-circuit failure detection line b and the short-circuit detection circuit 8 are examples of the “detector” and the “first detector” in the present invention. The short-circuit failure detection line a, the controller 4, and the FET control circuit 7 are examples of the “detector” and the “second detector” in the present invention.

An operation of the DC-DC converter 100 having the above configuration will be described below.

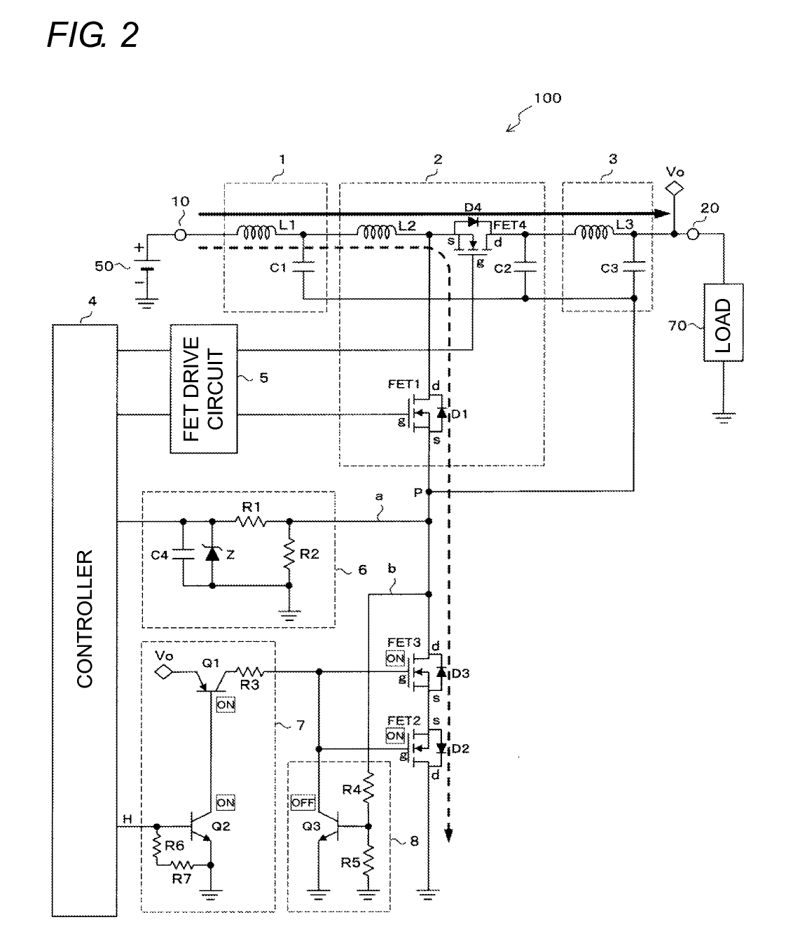

An operation in a normal state will be described first with reference to FIG. 2. When a host device (not shown) gives a boosting command to the controller 4, the controller 4 outputs a drive signal to the FET drive circuit 5. In response to the drive signal, the FET drive circuit 5 generates a pulse signal (see FIG. 1), and the pulse signal is output to the gates g of the FET 1 and the FET 4. The controller 4 outputs an H (high) level control signal to the FET control circuit 7. With the H level signal, the transistor Q2 of the FET control circuit 7 is turned on, and the transistor Q1 is also turned on. For this reason, since the voltage Vo is given to the gates g of the FET 2 and the FET 3 through the transistor Q1, both the FET 2 and the FET 3 are turned on. In a normal operation, the FET 2 and the FET 3 are kept in an always-on state. On the other hand, the transistor Q3 is in an off state.

The FET 1 and the FET 4, as described above, are alternately turned on/off with a pulse signal from the FET drive circuit 5. In FIG. 2, a solid thick arrow shows a current path obtained when the FET 4 is turned on, and a broken-line thick arrow shows a current path obtained when the FET 1 is turned on. With the on/off-operations of the FET 1 and the FET 4, the voltage of the DC power supply 50 input to the voltage converter circuit 2 is switched through the input filter 1 to generate a high voltage at the coil L2. The high voltage is rectified with the diode D4 of the FET 4, smoothed with the capacitor C2, and supplied to the load 70 as a boosted DC voltage through the output filter 3.

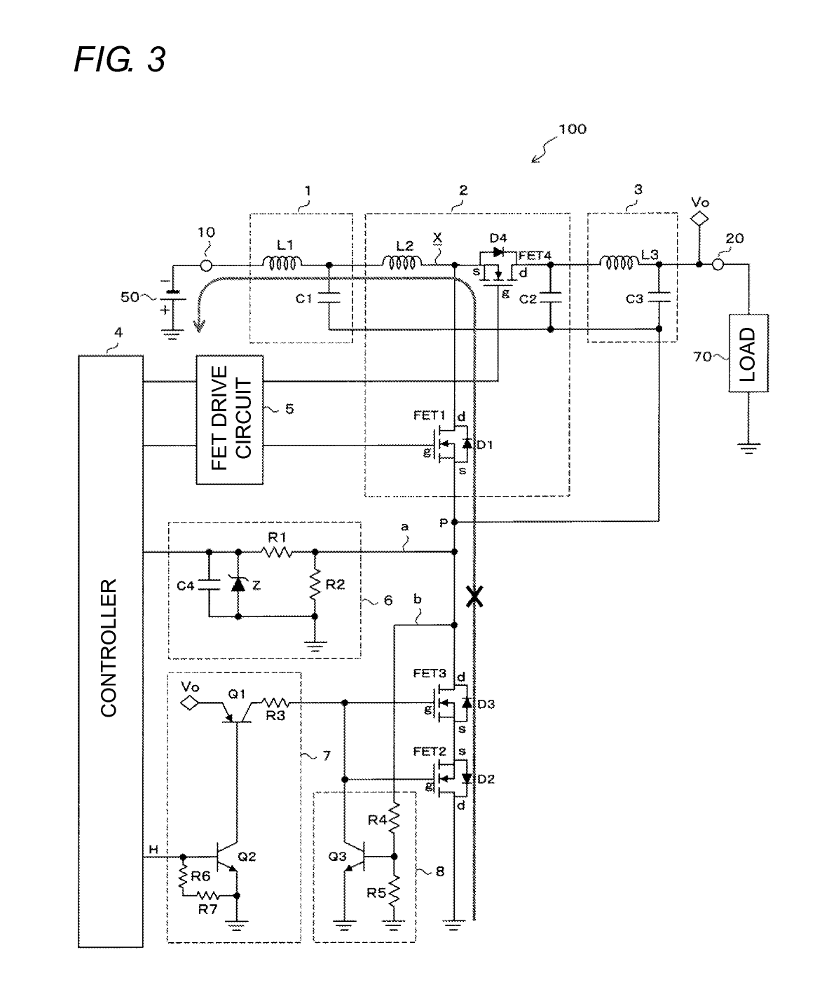

An operation performed when the DC power supply 50 is reversely connected will be described below with reference to FIG. 3.

As shown in FIG. 3, when the negative electrode and the positive electrode of the DC power supply 50 are connected to the input terminal 10 and the ground, respectively, if the reverse connection protection FET 2 is not disposed, a large current as shown in a thick arrow flows. This is because the diodes D1 and D3 are connected in a forward direction with respect to the DC power supply 50, and a current flows through the diodes D1 and D3 even though the FET 1 and the FET 3 are in an off state. However, when the reverse connection protection FET 2 is disposed, the diode D2 of the FET 2 is connected in a reverse direction with respect to the DC power supply 50, and the current path as indicated by the thick arrow is not formed. In this manner, in the reverse connection of the DC power supply 50, the circuit element in the current path can be prevented from being broken.

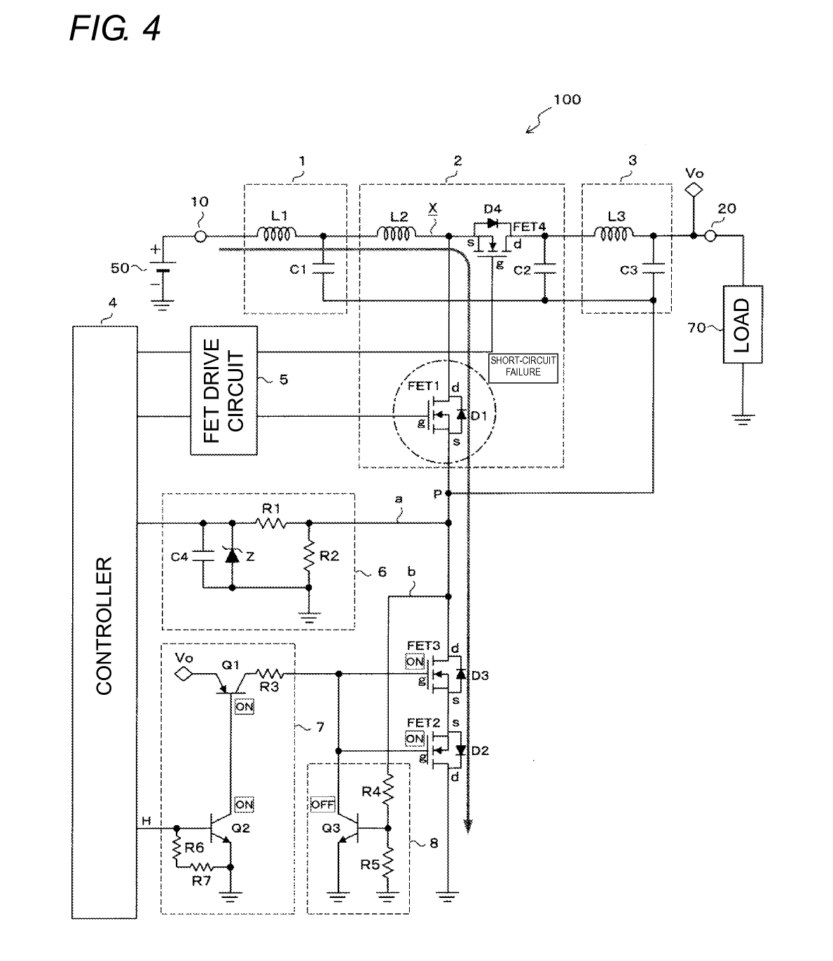

An operation performed when a short-circuit failure occurs in the FET 1 of the voltage converter circuit 2 will be described below with reference to FIG. 4 to FIGS. 8A and 8B.

When a short-circuit failure occurs in the FET 1, as described above, the conductive state between the source s and the drain d of the FET 1 is fixed, and the FET 1 is in an always-on state. Thus, since all the FET 1 to the FET 3 are turned on, as indicated by a thick arrow in FIG. 4, a large current flows in a path expressed by the positive electrode of the DC power supply 50 the coil L1→the coil L2→the FET 1→the FET 3→the FET 2→the ground→the negative electrode of the DC power supply 50. With the large current, a potential at the connection point P rises.

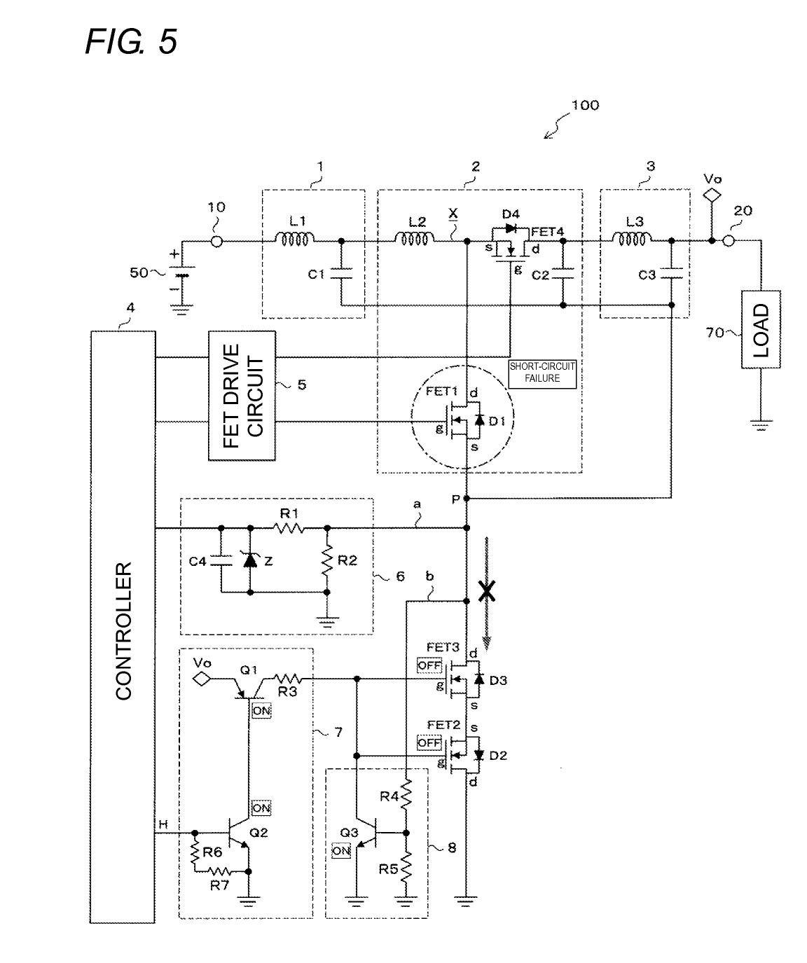

In this case, a current flowing in the path is given by lo, and resistances of the FET 2 and the FET 3 in an on state are given by r2 and r3, respectively. In this case, a voltage Vp appearing at the connection point P is given by Vp=lo·(r2+r3). The voltage Vp is given to the short-circuit detection circuit 8 through the short-circuit failure detection line b. In the short-circuit detection circuit 8, the voltage Vp is divided by a voltage-dividing circuit including the resistors R4 and R5. Thus, the voltage divided by the resistor R4 and the resistor R5 is applied to the base of the transistor Q3. A base voltage Vb of the transistor Q3 obtained at this time is given by Vb=Vp·R5/(R4+R5). Since the voltage Vb is set to be equal to or higher than a base voltage required to turn on the transistor Q3, as shown in FIG. 5, the transistor Q3 is turned on. As a result, the gates g of the FET 2 and the FET 3 are connected to the ground through the transistor Q3. Thus, both the FET 2 and the FET 3 are turned off due to a decrease in gate voltage.

In this state, the diode D2 of the FET 2 is connected in a forward direction with respect to the DC power supply 50, and the diode D3 of the FET 3 is connected in a reverse direction with respect to the DC power supply 50. Thus, a current path extending from the positive electrode of the DC power supply 50 to the ground through the FET 1 is not formed, and a large current generated by a short-circuit failure in the FET 1 is cut off by the FET 3 (and the diode D3).

In this manner, a short-circuit failure occurs in the FET 1 of the voltage converter circuit 2, the voltage Vp at the connection point P increases to turn on the transistor Q3, and the FET 3 is turned off. Thus, the large current that cannot be cut off by the FET 2 can be cut off by the FET 3. For this reason, in occurrence of a short-circuit failure in the FET 1, the current element disposed on the path in which a large current flows can be protected from being broken down.

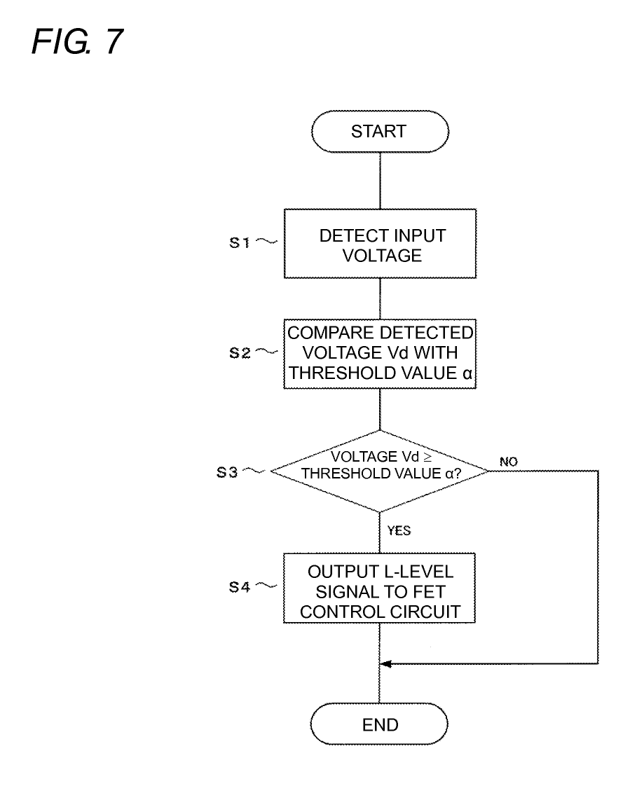

On the other hand, the voltage Vp at the connection point P is also given to the controller 4 through the short-circuit failure detection line a and the protection circuit 6. The controller 4, on the basis of the voltage Vp, determines the presence/absence of a short-circuit failure in the FET 1. An operation of the controller 4 will be described below with reference to the flow chart in FIG. 7. The steps in FIG. 7 are repetitively executed in a prescribed cycle by the CPU of the controller 4.

The voltage Vd depending on the voltage Vp at the connection point P is input to the controller 4 through the short-circuit failure detection line a. The controller 4 detects the voltage Vd in step S1. The controller 4, in step S2, compares the detected voltage Vd with a threshold value a. The threshold value a is set in a memory arranged in the controller 4 in advance. The controller 4, in step 53, determines whether the voltage Vd is the threshold value a or higher.

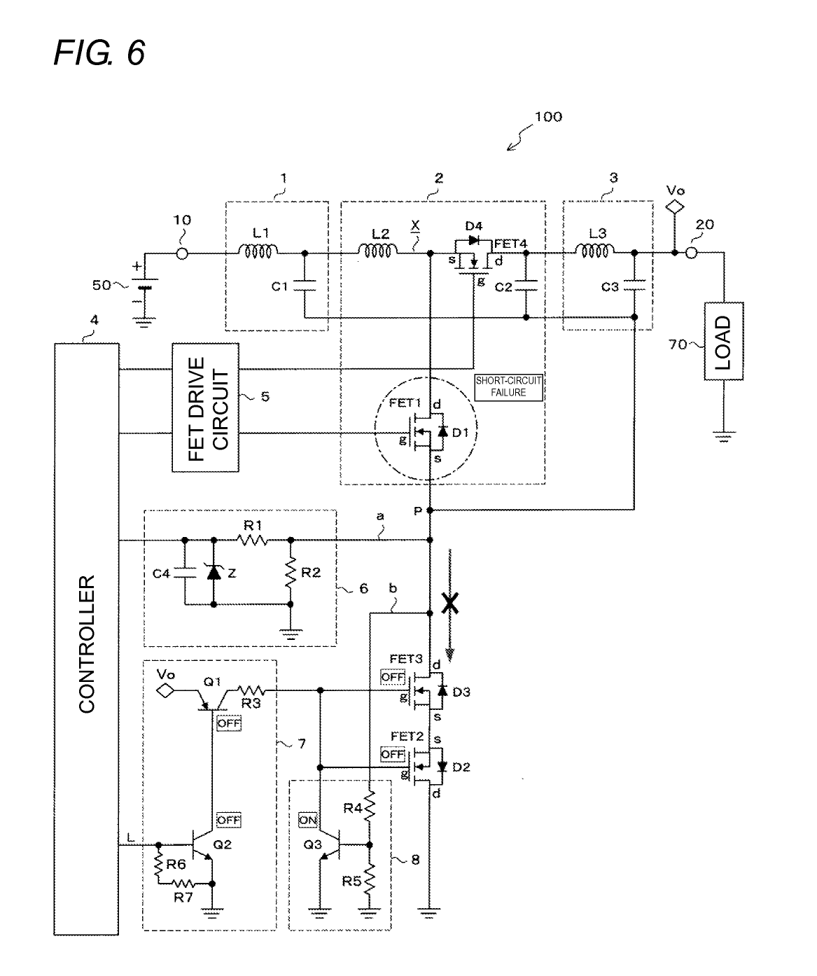

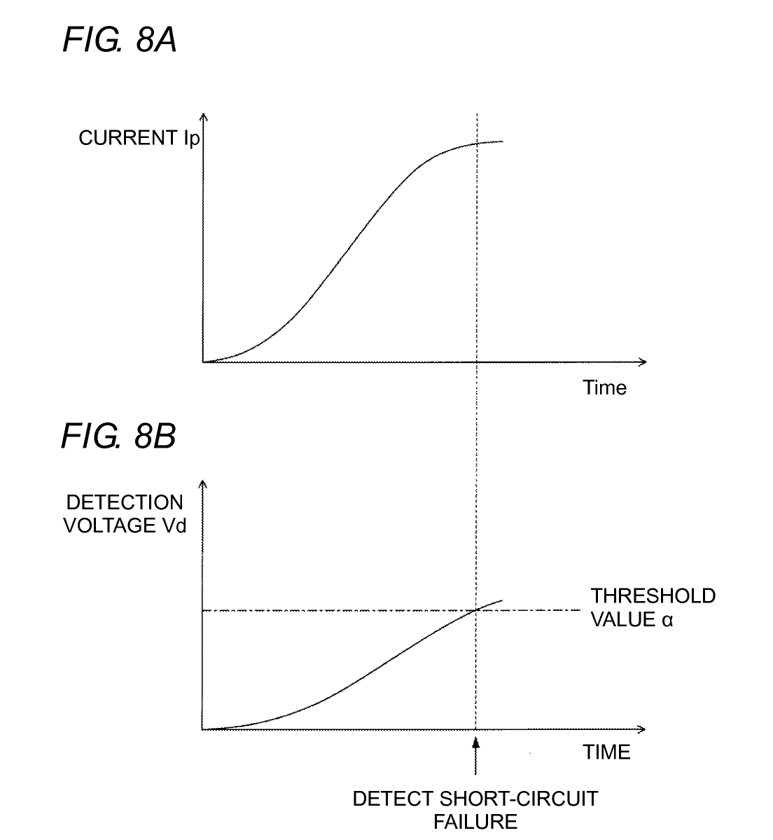

When a short-circuit failure occurs in FET 1, as shown in FIG. 8A, a current Ip at the connection point P increases, and the voltage Vp rises. As a result, the voltage Vd detected by the controller 4 also increases accordingly as shown in FIG. 8B. When the determination result in step S3 shows that the voltage Vd is the threshold value a or higher (step S3; YES), the controller 4 determines that a short-circuit failure occurs in the FET 1. The controller 4, in the next step S4, as shown in FIG. 6, outputs an L-(Low) level control signal to the FET control circuit 7. More specifically, the control signal given to the FET control circuit 7 by the controller 4 is switched from an H-level signal to an L-level signal. On the other hand, as a result of the determination in step S3, when the voltage Vd is lower than the threshold value a (step S3; NO), the process is ended without executing step S4.

By the L-level signal output from the controller 4 in step S4, as shown in FIG. 6, the transistor Q2 of the FET control circuit 7 is turned off, and the transistor Q1 is also turned off. At this point of time, since the transistor Q3 in the short-circuit detection circuit 8 is turned on, the FET 2 and the FET 3 have been turned off already. Thus, even though the transistor Q1 is turned off, the states of the FET 2 and the FET 3 do not change. However, when the transistor Q3 in the short-circuit detection circuit 8 is not turned on with some cause, the transistor Q1 is turned off to make it possible to turn off the FET 2 and the FET 3.

In this manner, in the embodiment, the first detector including the short-circuit failure detection line b and the short-circuit detection circuit 8 and the second detector including the controller 4 and the FET control circuit 7 are disposed to duplicate the means for detecting a short-circuit failure in the FET 1. Since the first detector includes only hardware (the transistor Q3 and the resistors R4 and R5), a time required to detect a short-circuit failure is short. In contrast to this, since the second detector requires software processing performed by the CPU in the controller 4, a time required to detect a short-circuit failure is longer than that required in the first detector. Thus, when a short-circuit failure occurs in the FET 1, first, the short-circuit detection circuit 8 in the first detector operates to turn off the FET 2 and the FET 3. Thereafter, the controller 4 and the FET control circuit 7 in the second detector operate to perform a backup operation in an abnormal state of the short-circuit detection circuit 8. For this reason, in occurrence of a short-circuit failure, the reliability of cutting-off of a large current can be improved.

In the embodiment, the capacitor C1 of the input filter 1, the capacitor C2 of the voltage converter circuit 2, and the capacitor C3 of the output filter 3 are connected between the power supply line X and the connection point P. For this reason, even though a short-circuit failure occurs in any one of the capacitors C1 to C3, the voltage Vp at the connection point P increases due to a large current flowing in the capacitors. Thus, not only a short-circuit failure in the FET 1 but also short-circuit failures in the capacitors C1 to C3 can be detected.

In one or more embodiments of the present invention, various modifications can be employed. For example, in the embodiments described above, when a short-circuit failure occurs in the FET 1, the transistor Q3 of the short-circuit detection circuit 8 is turned on to turn off the FET 2 and the FET 3 so as to cut off a large current. In place of this, a circuit configuration in which, when a short-circuit failure occurs in the FET 1, the transistor of the short-circuit detection circuit 8 is turned off to turn off the FET 2 and the FET 3 may be employed.

In one or more embodiments, the transistor Q1 of the FET control circuit 7 is turned on to turn on the FET 2 and the FET 3. However, a circuit configuration in which the transistor of the FET control circuit 7 is turned off to turn on the FET 2 and the FET 3 may be employed. In this case, when a short-circuit failure occurs in the FET 1, the transistor of the FET control circuit 7 is turned on.

In one or more embodiments, in the voltage converter circuit 2, the synchronous rectification FET 4 having the diode D4 is disposed to rectify a high voltage generated in the coil L2. However, a normal diode may be used in place of the FET 4.

In one or more embodiments, the FET is used as a switching element. However, a transistor may be used in place of the FET. Similarly, in place of the transistors Q1 to Q3 in one or more embodiments, FETs may be used. Furthermore, in place of the FET, a switching element such as an IGBT (Insulating Gate Bipolar Transistor) may be used.

In one or more embodiments, between the connection point P and the ground, the FET 2 is disposed on the ground side, and the FET 3 is disposed on the power supply side. However, the FET 2 may be disposed on the power supply side, and the FET 3 may be disposed on the ground side.

In one or more embodiments, as a means for detecting a short-circuit failure in the FET 1, the first detector including the short-circuit failure detection line b and the short-circuit detection circuit 8 and the second detector including the short-circuit failure detection line a, the controller 4, and the FET control circuit 7 are arranged. However, only one of the first detector and the second detector may be disposed. When only the second detector is disposed, the transistor Q1 of the FET control circuit 7 is turned off to turn off the FET 2 and FET 3, and a large current is cut off. Also in this case, such a circuit configuration that the FET 2 and the FET 3 are turned off by turning on the transistor of the FET control circuit 7 may be employed.

In one or more embodiments, although the voltage converter circuit 2 is configured by the booster circuit, depending on the specifications of a converted voltage, the voltage converter circuit 2 may be configured by a step-down circuit.

In one or more embodiments, the DC-DC converter 100 to be mounted on a vehicle is exemplified. However, one or more embodiments of the present invention can also be applied to a DC-DC converter used for applications other than the above application.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A DC-DC converter comprising:
an input terminal to which a positive electrode of a DC power supply is connected;
an output terminal to which a load is connected;
a voltage converter circuit that is disposed between the input terminal and the output terminal, has a first switching element, and boosts or steps down a voltage of the DC power supply depending on an on/off-operation of the first switching element to supply the voltage to the load; and
a reverse connection protection second switching element that blocks a large current from flowing in the voltage converter circuit when the negative electrode of the DC power supply is connected to the input terminal, and further comprising:
a short-circuit protection third switching element that blocks a large current from flowing in the voltage converter circuit when a short-circuit failure occurs in the first switching element; and
a detector that detects the short-circuit failure in the first switching element to turn off the third switching element, wherein
the third switching element is connected in series with the second switching element, and
the detector detects a failure on the basis of a voltage at a connection point between the first switching element and a series circuit of the second and third switching elements.

2. The DC-DC converter according to claim 1, wherein
the detector includes:
a voltage-dividing resistor that divides the voltage at the connection point; and
a fourth switching element that is turned on/off when the voltage divided by the voltage-dividing resistor is equal to or higher than a predetermined value, and
the third switching element is turned off by turning on/off the fourth switching element.

3. The DC-DC converter according to claim 1, wherein
the detector includes:
a controller that determines the presence/absence of a failure on the basis of the voltage at the connection point and outputs a control signal when the controller determines that the failure occurs; and
a fifth switching element that is turned on/off on the basis of the control signal, and
the third switching element is turned off by turning on/off the fifth switching element.

4. The DC-DC converter according to claim 1, wherein
the detector includes a first detector and a second detector,
the first detector includes a voltage-dividing resistor that divides the voltage at the connection point, and
a fourth switching element that is turned on/off when the voltage divided by the voltage-dividing resistor is equal to or larger than a predetermined value,
the second detector includes
a controller that determines the presence/absence of a failure on the basis of the voltage at the connection point and outputs a control signal when the controller determines that the failure occurs, and
a fifth switching element that is turned on/off on the basis of the control signal, and
the third switching element is turned off by turning on/off the fourth switching element in the first detector or turning on/off the fifth switching element in the second detector.

5. The DC-DC converter according to claim 1, wherein
the first to third switching elements include MOSFETs configured by arranging diodes between a source and a drain,
the diodes of the first and third switching elements are connected to the DC power supply in a reverse direction, and
the diode of the second switching element is connected to the DC power supply in a forward direction.

6. The DC-DC converter according to claim 5, wherein
the drain of the first switching element is connected to a power supply line on a positive electrode side of the DC power supply,
the source of the first switching element is connected to the drain of the third switching element,
the source of the third switching element is connected to the source of the second switching element, and
the drain of the second switching element is connected to the ground.

7. The DC-DC converter according to claim 2, wherein
the first to third switching elements include MOSFETs configured by arranging diodes between a source and a drain,
the diodes of the first and third switching elements are connected to the DC power supply in a reverse direction, and
the diode of the second switching element is connected to the DC power supply in a forward direction.

8. The DC-DC converter according to claim 3, wherein
the first to third switching elements include MOSFETs configured by arranging diodes between a source and a drain,
the diodes of the first and third switching elements are connected to the DC power supply in a reverse direction, and
the diode of the second switching element is connected to the DC power supply in a forward direction.

9. The DC-DC converter according to claim 4, wherein
the first to third switching elements include MOSFETs configured by arranging diodes between a source and a drain,
the diodes of the first and third switching elements are connected to the DC power supply in a reverse direction, and
the diode of the second switching element is connected to the DC power supply in a forward direction.

10. The DC-DC converter according to claim 7, wherein
the drain of the first switching element is connected to a power supply line on a positive electrode side of the DC power supply,
the source of the first switching element is connected to the drain of the third switching element,
the source of the third switching element is connected to the source of the second switching element, and
the drain of the second switching element is connected to the ground.

11. The DC-DC converter according to claim 8, wherein
the drain of the first switching element is connected to a power supply line on a positive electrode side of the DC power supply,
the source of the first switching element is connected to the drain of the third switching element,
the source of the third switching element is connected to the source of the second switching element, and
the drain of the second switching element is connected to the ground.

12. The DC-DC converter according to claim 9, wherein
the drain of the first switching element is connected to a power supply line on a positive electrode side of the DC power supply,
the source of the first switching element is connected to the drain of the third switching element,
the source of the third switching element is connected to the source of the second switching element, and
the drain of the second switching element is connected to the ground.
